(19) United States
(12) Patent Application Publication
(10) Pub. No.: US 2026/0302689 A1
(43) Pub. Date: Oct. 1, 2026

(54) CONNECTOR ASSEMBLY UTILIZING MAGNETS

(71) Applicant: Vertiv Corporation, Westerville, OH (US)

(72) Inventors: Akshay Anandarao Ghorpade, Shirol (IN); Dilesh Arvind Raut, Pune (IN)

(21) Appl. No.: 19/561,997

(22) Filed: Mar. 10, 2026

(30) Foreign Application Priority Data
Apr. 1, 2025 (IN) 202511032277

(51) Int. Cl. H01R 13/62; H01R 43/26

(52) U.S. Cl. CPC H01R 13/6205; H01R 43/26

(57) ABSTRACT

A connector assembly including a first connector and a second connector is disclosed. The first connector may include a plurality of metallic contact pads etched on a Printed Circuit Board (PCB), and a first pair of magnets of opposite polarity integrated at opposite ends of the first connector. The second connector may include a plurality of retractable pins mounted on a support pad and electrically connected at ends of a plurality of wires. The plurality of retractable pins may be configured to electrically contact the plurality of metallic contact pads. The second connector also includes a second pair of magnets of opposite polarity integrated at opposite ends of the second connector for mating with opposite poles of the first pair of magnets.

### CROSS-REFERENCE TO RELATED APPLICATIONS

The present application claims the benefit of India Provisional Application No. 202511032277 filed on Apr. 1, 2025, which is herein incorporated by reference in the entirety.

### TECHNICAL FIELD

The present disclosure generally relates to a connector assembly, and more particularly to a connector assembly utilizing magnets.

### BACKGROUND

Connectors of different types are used for connecting different devices for a variety of applications. For example, peripheral devices like keyboards, display units, data storage units/memory, and the like are connected with a computer using a variety of connectors, such as Universal Serial Bus (USB), Video Graphics Array (VGA), and the like.

Connectors are essential components used for linking various devices, and facilitating communication and functionality across different applications. They are designed for specific purposes, depending on the type of device, data transfer needs, and performance requirements. Common connectors include the Universal Serial Bus (USB) for connecting peripherals like keyboards, mice, and external storage devices, and Video Graphics Array (VGA) for linking monitors and projectors to computers, typically for analog video signals. Additionally, HDMI is used for transmitting high-definition video and audio, while Ethernet (RJ-45) connectors enable network connections.

### SUMMARY

This summary is provided to introduce aspects related to a connector assembly including two connectors. Both of the connectors utilize a pair of magnets that enable magnetic coupling/mating between them. One of the two connectors also include retractable pins, such as pogo pins that help in establishing data and power connections between both the connectors, upon coupling. As magnets are utilized for locking the connectors, the connector assembly can withstand repeated use and frequent connection/disconnection without degradation in performance. Further, the connector assembly ensures correct polarity of connection and proper pin alignment.

The present disclosure relates to a connector assembly including a first connector and a second connector. The first connector includes a plurality of metallic contact pads etched on a Printed Circuit Board (PCB), and a first pair of magnets of opposite polarity integrated at opposite ends of the first connector. The second connector includes a plurality of retractable pins mounted on a support pad and electrically connected at ends of a plurality of wires. The plurality of retractable pins are configured to make electrical contact with the plurality of metallic contact pads. The second connector also includes a second pair of magnets of opposite polarity integrated at opposite ends of the second connector for mating with opposite poles of the first pair of magnets.

A connector assembly is disclosed in accordance with one or more illustrative embodiments of the present disclosure. In one illustrative embodiment, the connector assembly includes a first connector. In another illustrative embodiment, the first connector includes a plurality of metallic contact pads on a rigid surface. In another illustrative embodiment, the first connector includes a first pair of magnets of opposite polarity integrated at opposite ends of the first connector. In another illustrative embodiment, the connector assembly includes a second connector. In another illustrative embodiment, the second connector includes a plurality of retractable pins mounted on a support pad and electrically connected at ends of a plurality of wires. In another illustrative embodiment, the plurality of retractable pins are configured to electrically contact the plurality of metallic contact pads during mating of the second connector with the first connector to establish data and power connection. In another illustrative embodiment, the second connector includes a second pair of magnets of opposite polarity integrated at opposite ends of the second connector for mating with opposite poles of the first pair of magnets and for magnetically coupling the second connector to the first connector.

In a further aspect, the plurality of metallic contact pads may be at least one of a rectangular shape, an elliptical shape, a square shape, or a circular shape, and the rigid surface includes a Printed Circuit Board (PCB).

In a further aspect, at least one of the first connector or the second connector may correspond to a count and arrangement of one connector selected from a group consisting of a Universal Serial Bus (USB) connector, High Definition Multimedia Interface (HDMI) DisplayPort connector, Video Graphics Array (VGA) connector, Serial Advanced Technology Attachment (SATA) connector, Peripheral Component Interconnect Express (PCIe) connector, PS/2, FireWire (IEEE 1394) connector, Thunderbolt connector, Digital Visual Interface (DVI) connector, Lightning Connector, M.2 connector, and External SATA (eSATA) connector.

In a further aspect, the plurality of retractable pins may be pogo pins.

In a further aspect, the support pad may be made using glass, epoxy, or plastic.

A connector is disclosed in accordance with one or more illustrative embodiments of the present disclosure. In one illustrative embodiment, the connector includes a plurality of retractable pins mounted on a support pad and electrically connected at ends of a plurality of wires. In another illustrative embodiment, the plurality of retractable pins are configured to electrically contact a plurality of metallic contact pads present on another connector to establish data and power connection. In another illustrative embodiment, the connector includes a pair of magnets of opposite polarity integrated at opposite ends of the connector for mating with opposite poles of another pair of magnets present on the another connector and for magnetically coupling the another connector to the connector.

In a further aspect, the plurality of metallic contact pads may be at least one of a rectangular shape, an elliptical shape, a square shape, or a circular shape.

In a further aspect, the connector may correspond to a count and arrangement of one connector selected from a group consisting of a Universal Serial Bus (USB) connector, High Definition Multimedia Interface (HDMI) DisplayPort connector, Video Graphics Array (VGA) connector, Serial Advanced Technology Attachment (SATA) connector, Peripheral Component Interconnect Express (PCIe) connector, PS/2, FireWire (IEEE 1394) connector, Thunderbolt connector, Digital Visual Interface (DVI) connector, Lightning Connector, M.2 connector, and External SATA (eSATA) connector.

In a further aspect, the plurality of retractable pins may be pogo pins.

In a further aspect, the support pad may be made using glass, epoxy, or plastic.

A connector is disclosed in accordance with one or more illustrative embodiments of the present disclosure. In one illustrative embodiment, the connector includes a plurality of metallic contact pads on a rigid surface. In another illustrative embodiment, the plurality of metallic contact pads are configured to electrically contact a plurality of retractable pins present on another connector to establish data and power connection. In another illustrative embodiment, the connector includes a pair of magnets of opposite polarity integrated at opposite ends of the connector for magnetically coupling the connector to the another connector.

In a further aspect, the plurality of metallic contact pads may be at least one of a rectangular shape, an elliptical shape, a square shape, or a circular shape.

In a further aspect, the rigid surface may include a Printed Circuit Board (PCB) including a non-conductive laminate including at least one of FR-4, ceramic, or composite epoxy material.

In a further aspect, the plurality of metallic contact pads may be arranged in at least one of a linear, circular, elliptical, or rectangular pattern.

In a further aspect, a count and arrangement of the plurality of metallic contact pads may correspond to one connector selected from a group consisting of a Universal Serial Bus (USB) connector, a High Definition Multimedia Interface (HDMI) DisplayPort connector, a Video Graphics Array (VGA) connector, a Serial Advanced Technology Attachment (SATA) connector, a Peripheral Component Interconnect Express (PCIe) connector, a PS/2 connector, a FireWire (IEEE 1394) connector, a Thunderbolt connector, a Digital Visual Interface (DVI) connector, a Lightning connector, an M.2 connector, and an External SATA (eSATA) connector.

A method of establishing an electrical connection using a connector assembly is disclosed in accordance with one or more illustrative embodiments of the present disclosure. In one illustrative embodiment, the method includes mating a second connector with a first connector by magnetically coupling a second pair of magnets of opposite polarity integrated at opposite ends of the second connector with opposite poles of a first pair of magnets of opposite polarity integrated at opposite ends of the first connector. In another illustrative embodiment, the method includes establishing data and power connection during the mating by a plurality of retractable pins mounted on a support pad of the second connector making electrical contact with a plurality of metallic contact pads on a rigid surface of the first connector.

In a further aspect, the mating of the second connector with the first connector may occur only in a desired orientation where opposite poles of the first pair of magnets and the second pair of magnets come in contact with each other.

In a further aspect, the plurality of retractable pins may be pogo pins, each pogo pin including a plunger, a barrel, and a spring positioned therebetween.

In a further aspect, the plurality of metallic contact pads may be at least one of a rectangular shape, an elliptical shape, a square shape, or a circular shape.

In a further aspect, the plurality of retractable pins may be electrically connected at ends of a plurality of wires, and the plurality of wires includes at least one data line and at least one power line.

Other aspects and advantages of the invention will become apparent from the following detailed description, taken in conjunction with the accompanying drawings, illustrating by way of example the principles of the invention. This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a schematic representation of a connector assembly, in accordance with one or more embodiments of the present disclosure.

FIG. 2 illustrates a top view of metallic contact pads of different shapes, in accordance with one or more embodiments of the present disclosure.

FIG. 3 illustrates a flow diagram showing a method of establishing an electrical connection using a connector assembly, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Debugging of firmware is one application that may require frequent connection and disconnection of connectors. During firmware development, engineers are often required to perform debugging operations (i.e. finding and fixing errors in the firmware). A debugger (e.g., software tool loaded on a computer for performing debugging operation) generally uses Joint Test Action Group (JTAG) or Serial Wire Debug (SWD) communication with a controller to load a program for debugging. Conventional mechanical connectors used for the JTAG/SWD communication may provide relatively low reliability. When the mechanical connectors aren't aligned properly, communication gets hampered and hardware gets damaged. Further, the mechanical connectors may utilize snap-fit mechanism for locking, and their performance degrades over repeated use.

To overcome the aforementioned limitations associated with mechanical connectors, embodiments of the present disclosure provide a connector assembly utilizing magnets for locking. Magnetic coupling between connectors may prevent misalignment and any damage over time. In one or more embodiments, the connectors also utilize retractable pins, such as pogo pins that help in establishing data and/or power connections between both the connectors upon coupling. Usage of magnets and retractable pins increases life of the connector assembly.

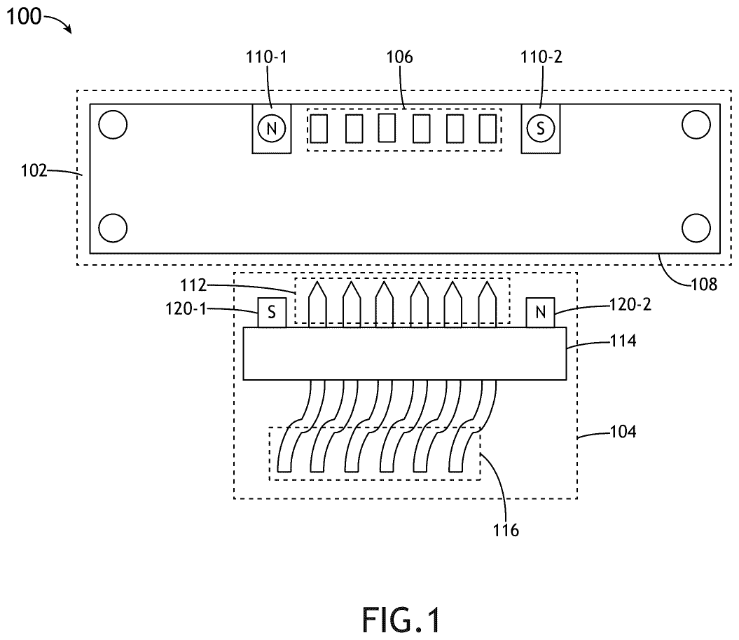

FIG. 1 illustrates a schematic representation of a connector assembly 100, in accordance with one or more embodiments of the present disclosure. The connector assembly 100 includes a first connector 102 (which may be alternatively referred to as a female connector) and a second connector 104 (which may be alternatively referred to as a male connector).

In embodiments, the first connector 102 includes a plurality of metallic contact pads 106 provided on a rigid surface. In one implementation, the metallic contact pads 106 may be etched on a Printed Circuit Board (PCB) 108. The PCB 108 may include non-conductive laminate made of different substrate materials, such as FR-4, ceramic, and/or composite epoxy material. A count and arrangement of the metallic contact pads 106 may vary in different implementations, depending on connector design requirements. In some implementations, the metallic contact pads 106 may be arranged in linear, circular, elliptical, or rectangular patterns. For example, four metallic contact pads may be provided in a linear arrangement for implementing a Universal Serial Bus (USB) type-A connector. In another example, two metallic contact pads may be provided in each of two rows present one above another for implementing a USB type-B connector.

Similarly, other connectors including, but not limited to, High Definition Multimedia Interface (HDMI), DisplayPort, Video Graphics Array (VGA), Serial Advanced Technology Attachment (SATA), Peripheral Component Interconnect Express (PCIe), PS/2, FireWire (IEEE 1394), Thunderbolt, Digital Visual Interface (DVI), Lightning Connector, M.2, and External SATA (eSATA) may be implemented by providing different number of metallic contact pads in different arrangements.

The first connector 102 may also include a first pair of magnets 110-1, 110-2 of opposite polarity. The first pair of magnets 110-1, 110-2 may be integrated at opposite ends of the first connector 102. As shown in FIG. 1, a first magnet 110-1 of North polarity is provided on left side of the first connector 102 and a second magnet 110-2 of South polarity is provided on right side of the first connector 102. Note that these are non-limiting examples and polarities of the first magnet 110-1 and the second magnet 110-2 may also be reversed and their position may also be changed depending on requirements.

The second connector 104 of the connector assembly 100 includes a plurality of retractable pins 112 mounted on a support pad 114. In one implementation, the plurality of retractable pins 112 may be pogo pins. Each pogo pin may include a plunger, a barrel, and a spring positioned therebetween. The plunger moves inside the barrel and the spring is compressed upon application of force on the pogo pin. The support pad 114 may be made of an insulating material such as glass, epoxy, or plastic.

The plurality of retractable pins 112 may be electrically connected at ends of a plurality of wires 116. Some of the plurality of wires 116 may be data lines and others may be power lines, depending on a type of the second connector 104. The plurality of retractable pins 112 may be configured to contact the plurality of metallic contact pads 106, during mating of the second connector 104 with the first connector 102, to establish data and/or power connection.

The second connector 104 may also include a second pair of magnets 120-1, 120-2 of opposite polarity integrated at opposite ends of the second connector 104 for mating with opposite poles of the first pair of magnets 110-1, 110-2. As shown in FIG. 1, the first magnet 110-1 of North polarity is configured to mate with a third magnet 120-1 of South polarity, and a second magnet 110-2 of South polarity is configured to mate with a fourth magnet 120-2 of North polarity. In embodiments, due to said arrangement of magnets, the first connector 102 and the second connector 104 would mate only in a single desired orientation (i.e. an orientation in which magnets of opposite polarities come in contact with each other). In this manner, mating between the first connector 102 and the second connector 104 in an opposite orientation (in which magnets of same polarities are present against each other) would not take place. The magnets would oppose each other. This would prevent wrong connection between the plurality of retractable pins 112 and the plurality of metallic contact pads 106, thereby preventing any electrical damage of components connected with the connector assembly 100.

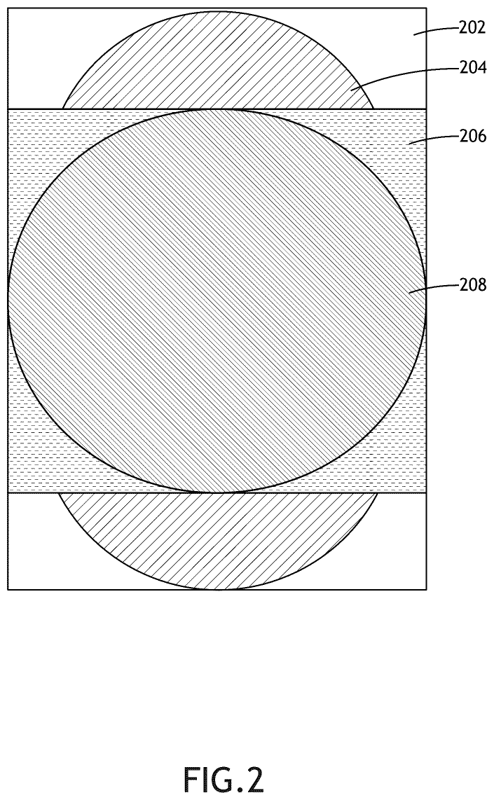

FIG. 2 illustrates a top view of metallic contact pads of different shapes. As illustrated, the metallic contact pads can be of any suitable shape such as a rectangular shape 202 similar to the plurality of metallic contact pads 106 shown in FIG. 1. Other shapes include an elliptical shape 204, a square shape 206, and/or a circular shape 208. It may be observed that the metallic contact pads having a rectangular shape 202 may advantageously have the largest surface area for contacting the plurality of retractable pins 112 and thus may increase the reliability of alignment and connection.

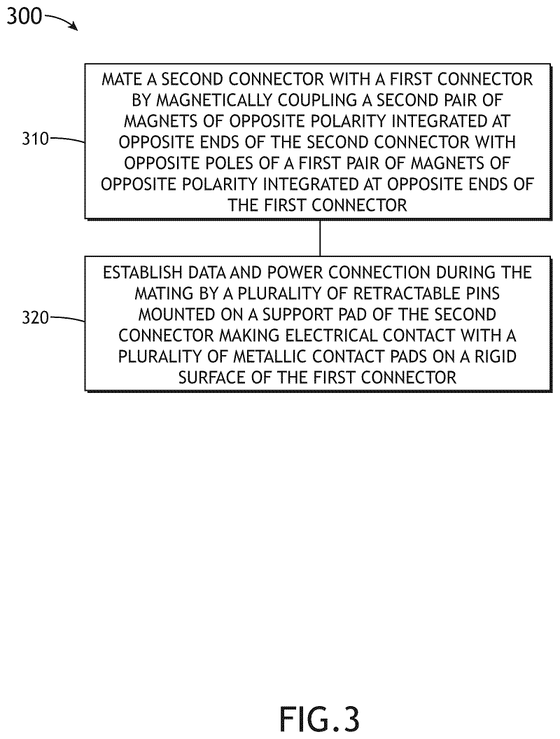

Referring now to FIG. 3, a method 300 of establishing an electrical connection using the connector assembly 100 is illustrated. The method 300 may be implemented using the connector assembly 100, including the first connector 102 and the second connector 104 described herein, and may include the following steps.

At a step 310, a second connector 104 is mated with a first connector 102 by magnetically coupling a second pair of magnets 120-1, 120-2 of opposite polarity integrated at opposite ends of the second connector 104 with opposite poles of a first pair of magnets 110-1, 110-2 of opposite polarity integrated at opposite ends of the first connector 102. For example, the first magnet 110-1 of North polarity is configured to magnetically couple with the third magnet 120-1 of South polarity, and the second magnet 110-2 of South polarity is configured to magnetically couple with the fourth magnet 120-2 of North polarity. In this manner, the mating of the second connector 104 with the first connector 102 may occur only in a desired orientation in which opposite poles of the first pair of magnets 110-1, 110-2 and the second pair of magnets 120-1, 120-2 come in contact with each other, thereby preventing incorrect mating in an opposite orientation.

At a step 320, data and power connection is established during the mating by a plurality of retractable pins 112 mounted on a support pad 114 of the second connector 104 making electrical contact with a plurality of metallic contact pads 106 on a rigid surface of the first connector 102. For example, the plurality of retractable pins 112 may be pogo pins, each pogo pin comprising a plunger, a barrel, and a spring positioned therebetween, wherein the plunger moves inside the barrel and the spring is compressed upon application of force during mating. The plurality of metallic contact pads 106 may be at least one of a rectangular shape, an elliptical shape, a square shape, or a circular shape. The plurality of retractable pins 112 may be electrically connected at ends of a plurality of wires 116, wherein the plurality of wires 116 comprises at least one data line and at least one power line, such that both data and power connections are simultaneously established upon mating of the second connector 104 with the first connector 102.

The connector assembly disclosed in the present disclosure may offer various technical advantages. The connector assembly may prevent mating between the first/female connector and the second/male connector in wrong orientations, and ensure correct polarity of connection and pin alignment. By preventing mating in wrong orientations, mechanical and/or electrical damage of components connected through the connector assembly may be prevented. Further, because the connector assembly utilizes magnets instead of mechanical snap-fit mechanism, the connector assembly can withstand repeated use and frequent connection/disconnection without degradation, or with less degradation, in mechanical performance.

The methods, systems, and/or devices discussed herein are examples. Various embodiments may omit, substitute, or add various procedures or components as appropriate. For instance, in alternative embodiments, the methods may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples and do not limit the scope of the disclosure or claims.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, +5%, or ±0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems and/or methods have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A connector assembly, comprising:
a first connector comprising:
a plurality of metallic contact pads on a rigid surface; and
a first pair of magnets of opposite polarity integrated at opposite ends of the first connector; and
a second connector comprising:
a plurality of retractable pins mounted on a support pad and electrically connected at ends of a plurality of wires, wherein the plurality of retractable pins are configured to electrically contact the plurality of metallic contact pads, during mating of the second connector with the first connector, to establish data and power connection; and
a second pair of magnets of opposite polarity integrated at opposite ends of the second connector for mating with opposite poles of the first pair of magnets and for magnetically coupling the second connector to the first connector.

2. The connector assembly as claimed in claim 1, wherein the plurality of metallic contact pads are at least one of a rectangular shape, an elliptical shape, a square shape, or a circular shape, and wherein the rigid surface comprises a Printed Circuit Board (PCB).

3. The connector assembly as claimed in claim 1, wherein at least one of the first connector or the second connector corresponds to a count and arrangement of one connector selected from a group consisting of a: Universal Serial Bus (USB) connector, High Definition Multimedia Interface (HDMI) connector, DisplayPort connector, Video Graphics Array (VGA) connector, Serial Advanced Technology Attachment (SATA) connector, Peripheral Component Interconnect Express (PCIe) connector, PS/2, FireWire (IEEE 1394) connector, Thunderbolt connector, Digital Visual Interface (DVI) connector, Lightning Connector, M.2 connector, and External SATA (eSATA) connector.

4. The connector assembly as claimed in claim 1, wherein the plurality of retractable pins are pogo pins.

5. The connector assembly as claimed in claim 1, wherein the support pad is made using glass, epoxy, or plastic.

6. A connector, comprising:
a plurality of retractable pins mounted on a support pad and electrically connected at ends of a plurality of wires, wherein the plurality of retractable pins are configured to electrically contact a plurality of metallic contact pads present on another connector, to establish data and power connection; and
a pair of magnets of opposite polarity integrated at opposite ends of the connector for mating with opposite poles of another pair of magnets present on the another connector and for magnetically coupling the another connector to the connector.

7. The connector as claimed in claim 6, wherein the plurality of metallic contact pads are at least one of a rectangular shape, an elliptical shape, a square shape, or a circular shape.

8. The connector as claimed in claim 6, wherein the connector corresponds to a count and arrangement of one connector selected from a group consisting of a: Universal Serial Bus (USB) connector, High Definition Multimedia Interface (HDMI) connector, DisplayPort connector, Video Graphics Array (VGA) connector, Serial Advanced Technology Attachment (SATA) connector, Peripheral Component Interconnect Express (PCIe) connector, PS/2, FireWire (IEEE 1394) connector, Thunderbolt connector, Digital Visual Interface (DVI) connector, Lightning Connector, M.2 connector, and External SATA (eSATA) connector.

9. The connector as claimed in claim 6, wherein the plurality of retractable pins are pogo pins.

10. The connector as claimed in claim 6, wherein the support pad is made using glass, epoxy, or plastic.

11. A connector, comprising:
a plurality of metallic contact pads on a rigid surface, wherein the plurality of metallic contact pads are configured to electrically contact a plurality of retractable pins present on another connector, to establish data and power connection; and
a pair of magnets of opposite polarity integrated at opposite ends of the connector for magnetically coupling the connector to the another connector.

12. The connector as claimed in claim 11, wherein the plurality of metallic contact pads are at least one of a rectangular shape, an elliptical shape, a square shape, or a circular shape.

13. The connector as claimed in claim 11, wherein the rigid surface comprises a Printed Circuit Board (PCB) comprising a non-conductive laminate comprising at least one of FR-4, ceramic, or composite epoxy material.

14. The connector as claimed in claim 11, wherein the plurality of metallic contact pads are arranged in at least one of a linear, circular, elliptical, or rectangular pattern.

15. The connector as claimed in claim 11, wherein a count and arrangement of the plurality of metallic contact pads corresponds to one connector selected from a group consisting of: a Universal Serial Bus (USB) connector, a High Definition Multimedia Interface (HDMI) connector, DisplayPort connector, a Video Graphics Array (VGA) connector, a Serial Advanced Technology Attachment (SATA) connector, a Peripheral Component Interconnect Express (PCIe) connector, a PS/2 connector, a FireWire (IEEE 1394) connector, a Thunderbolt connector, a Digital Visual Interface (DVI) connector, a Lightning connector, an M.2 connector, and an External SATA (eSATA) connector.

16. A method of establishing an electrical connection using a connector assembly, the method comprising:
mating a second connector with a first connector by magnetically coupling a second pair of magnets of opposite polarity integrated at opposite ends of the second connector with opposite poles of a first pair of magnets of opposite polarity integrated at opposite ends of the first connector; and
establishing data and power connection, during the mating, by a plurality of retractable pins mounted on a support pad of the second connector making electrical contact with a plurality of metallic contact pads on a rigid surface of the first connector.

17. The method as claimed in claim 16, wherein the mating of the second connector with the first connector occurs only in a desired orientation in which opposite poles of the first pair of magnets and the second pair of magnets come in contact with each other.

18. The method as claimed in claim 16, wherein the plurality of retractable pins are pogo pins, each pogo pin comprising a plunger, a barrel, and a spring positioned therebetween.

19. The method as claimed in claim 16, wherein the plurality of metallic contact pads are at least one of a rectangular shape, an elliptical shape, a square shape, or a circular shape.

20. The method as claimed in claim 16, wherein the plurality of retractable pins are electrically connected at ends of a plurality of wires, and wherein the plurality of wires comprises at least one data line and at least one power line.
